(19) United States
(12) Patent Application Publication
(10) Pub. No.: US 2011/0119629 A1
(43) Pub. Date: May 19, 2011

(54) Graphical User Interface, a Method, a Device and a Computer Program for Providing a Menu and/or Inputting an Access Code

(76) Inventors: Vesa Huotari, Tampere (FI); Nina Maaninka, Tampere (FI)

(21) Appl. No.: 12/083,298

(22) PCT Filed: Oct. 7, 2005
(86) PCT No.: PCT/IB2005/003247

§ 371 Date: Sep. 8, 2009

(51) Int. Cl. G06F 3/048

(52) U.S. Cl. 715/836; 715/849

(57) ABSTRACT

A graphical user interface, for inputting an access code, includes one or more entities visually representing, respectively, one or more three dimensional objects that have a first height dimension, a second width dimension and a third depth dimension; and a user input for controlling rotation of the one or more respective three dimensional objects at least in the third depth dimension, wherein a defined access code corresponds to a combination of different rotations of the one or more three dimensional objects.

### FIELD OF THE INVENTION

Embodiments of the present invention relate to a graphical user interface, a method, a device and a computer program for providing a menu and/or inputting an access code.

### BACKGROUND TO THE INVENTION

It is now common practice for electronic devices to have graphical user interfaces. A graphical user interface (GUI) provides a graphics based interface by which a user can operate an electronic device. GUIs may be used for menus by which a user can select, for example, a particular application or service.

A graphical user interface is typically a two-dimensional page on which a number of different icons are positioned. There is clearly a relationship between the size of an icon and hence the information it can convey, the number of icons and the size of the two-dimensional page. This may become problematic as the size or number of icons relative to the page size increases.

This problem has, in part, been addressed by using a menu is arranged as a hierarchical tree. Selecting at icon at the root of the hierarchical tree opens a window to a sub-menu in which further options are listed.

US2003/0156146 identifies a potential problem with such a menu, in that only a very limited portion of the all the options are visible to a user at any one time. The patent application discloses a GUI comprising a three-dimensional polyhedron that provides a more extensive immediate overview of the available options. For example, a diamond is used for a menu. The diamond has one facet facing the user, and this facet comprises the first menu item. All other menu items are at least a little visible on side facets of the diamond. The user rotates the diamond until the facet having the desired menu item is presented facing the user. This ‘active’ facet can then be selected by the user.

### BRIEF DESCRIPTION OF THE INVENTION

It would be desirable to provide an alternative GUI.

It would be useful if the alternative GUI could, for example, be used for other functions such as for controlling access to the device, its functions or related services.

It would be useful if the alternative GUI could, for example, be used to provide a menu, for example, a hierarchical menu.

According to one aspect of the invention there is provided a graphical user interface, for inputting an access code, comprising: one or more entities visually representing, respectively, one or more three dimensional objects that have a first height dimension, a second width dimension and a third depth dimension; and a user input for controlling rotation of the one or more respective three dimensional objects at least in the third depth dimension, wherein a defined access code corresponds to a combination of different rotations of the one or more three dimensional objects.

The different rotations may be about one or more axes. The rotations may be independent of the original orientation of the 3D object or, alternatively, the rotations may be dependent on the original orientation of the 3D object.

According to another aspect of the invention there is provided a method for enabling input of an access code, comprising: displaying one or more entities visually representing, respectively, one or more three dimensional objects that have a first height dimension, a second width dimension and a third depth dimension; and controlling, in response to user input, rotation of the one or more respective three dimensional objects at least in the third depth dimension, wherein a defined access code corresponds to a combination of different rotations of the one or more three dimensional objects.

According to another aspect of the invention there is provided an electronic device comprising: a display for displaying one or more entities visually representing, respectively, one or more three dimensional objects that have a first height dimension, a second width dimension and a third depth dimension; and a user input for controlling rotation of the one or more respective three dimensional objects at least in the third depth dimension, wherein combination of different rotations of the one or more three dimensional objects corresponds to a defined access code.

According to another aspect of the invention there is provided a computer program which when loaded into a processor enables a graphical user interface, for inputting an access code, the graphical user interface comprising:

one or more entities visually representing, respectively, one or more three dimensional objects that have a first height dimension, a second width dimension and a third depth dimension; and

a user input for controlling rotation of the one or more respective three dimensional objects at least in the third depth dimension, wherein a combination of different rotations of the one or more three dimensional objects corresponds to a defined access code.

According to another aspect of the invention there is provided a graphical menu for operation by a user, the menu simultaneously comprising a first entity and a second entity, wherein the first entity:
a) represents a first three dimensional (3D) object, wherein the first 3D object is rotatable to adopt any one of a first plurality of different orientations in each of which a different one of a first plurality of different portions of a surface area of the first 3D object is presented to the user,
b) has a first plurality of different appearances, each of which reproduces a corresponding different one of the first plurality of portions of the surface area of the first 3D object and each of which presents one or more user selectable options and/or one or more information items to the user; and
c) changes from one appearance to another, in response to a user input such that the first 3D object represented by the first entity rotates,
   wherein the second entity:
d) represents a second three dimensional (3D) object, wherein the second 3D object is rotatable to adopt any one of a second plurality of different orientations in each of which a different one of a second plurality of different portions of a surface area of the second 3D object is presented to the user,
e) has a second plurality of different appearances, each of which reproduces a corresponding different one of the second plurality of portions of the surface area of the second 3D object and each of which presents one or more user selectable options and/or one or more information items to the user; and
f) changes from one appearance to another, in response to a user input such that the second 3D object represented by the second entity rotates.

According to another aspect of the invention there is provided a graphical menu for operation by a user, the menu comprising:

an entity:
a) representing a virtual three dimensional object, wherein the object is rotatable to adopt any one of a plurality of different orientations in each of which a different one of a plurality of different portions of a surface area of the object is presented to the user;
b) has a plurality of different appearances, each of which reproduces a corresponding different one of the plurality of portions of the surface area of the object;
c) and the entity changes from one appearance to another, in response to a user input, such that the virtual three dimensional object represented by the entity rotates,
wherein at least one of the plurality of different appearances of the entity presents a multiplicity of user selectable options.

According to another aspect of the invention there is provided a method of inputting an access code using a navigable menu, comprising:

navigating a predefined route within the menu without selecting a menu item

### BRIEF DESCRIPTION OF THE DRAWINGS

For a better understanding of the present invention reference will now be made by way of example only to the accompanying drawings in which:

FIG. 1 schematically illustrates a graphical user interface (GUI) 10 according to a first embodiment;

FIG. 2 illustrates a menu arranged as a hierarchical tree;

FIG. 3 schematically illustrates a graphical user interface (GUI) 10′ according to a second embodiment; and

FIG. 4 schematically illustrates an electronic device for providing a GUI 10, 10′.

### DETAILED DESCRIPTION OF EMBODIMENTS OF THE INVENTION

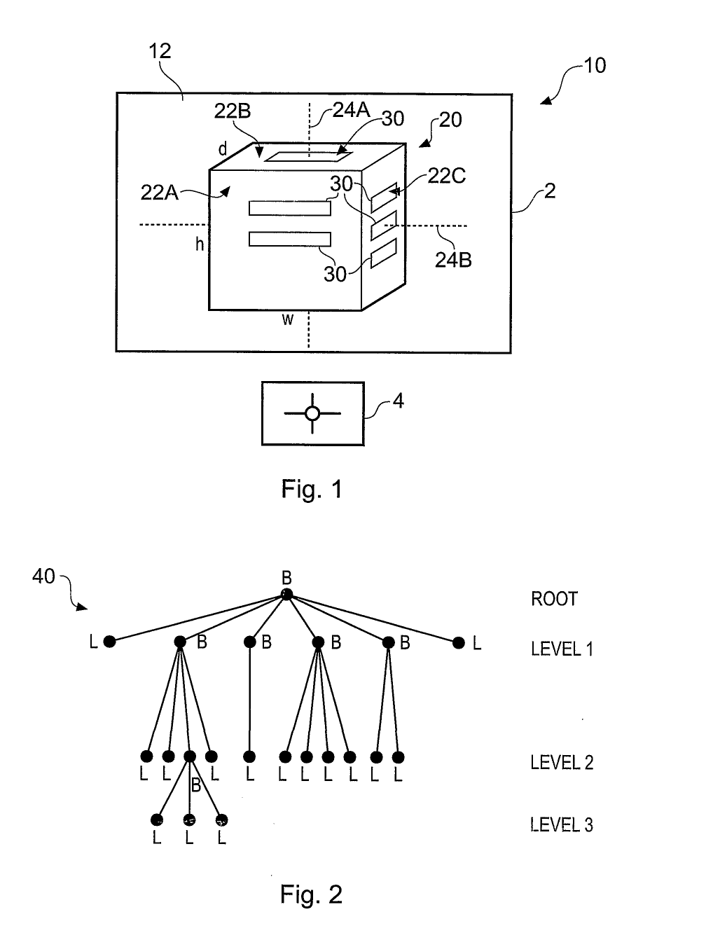

FIG. 1 schematically illustrates a graphical user interface (GUI) 10 according to a first embodiment.

The GUI 10 provides an output via a display area 12 provided by a display 2 and, optionally, a loudspeaker (not illustrated) and receives input from a user via one or more appropriate user input devices 4. A user input device 4 may be a device that is physically separated from the display 2 such as a keypad, joystick, roller etc. or may be integrated with the display 2 as a touch screen.

The GUI 10 provides, in the display area, a visual entity 20. The visual entity 20 visually represents a three dimensional (3D) object, which in this example is a cube.

The 3D object has a height dimension h, a width dimension w and a depth dimension d, which are mutually orthogonal in the geometry of the object. In this example, the visual entity 20 represents the 3D object as if viewed from a top-right perspective

The 3D object is rotatable to adopt any one of a plurality of different orientations. In each of these orientations, a different portion 22A, 22B, 22C . . . of a surface area of the 3D object is presented to the user. The visual entity has a different appearance for each orientation of the 3D object and each appearance reproduces a corresponding different one of the plurality of portions 22A, 22B . . . of the surface area of the object. User input via the user input device 4 changes the entity from one appearance to another such that the 3D object represented by the entity rotates in a manner controlled by the user.

In the illustrated example, the cube is rotatable to adopt any one of six different orientations. In each of these orientations, a different face 22A, 22B, 22C . . . of the cube is presented to the user. The visual entity has a different appearance for each orientation of the 3D object and each appearance reproduces a corresponding different face of the cube. User input via the user input device 4 changes the entity from one appearance to another such that the 3D object represented by the entity rotates in a manner controlled by the user so that a desired face 22A, 22B, 22C of the cube can be presented to a user.

The 3D object is rotatable about one or more axes of rotation. In the example illustrated, the object is a cube and has rotation symmetry. A first axis of rotation 24A is coincident with one axis of rotational symmetry of the 3D object and a second axis of rotation 24B is coincident with a different axis of rotational symmetry of the 3D object. The axes of rotation 24A, 24B are fixed and do not rotate with rotation of the 3D object.

The first axis of rotation 24A runs parallel to the height dimension of the cube and rotation about this axis is in the depthwise direction. The vector of the rotation is coincident with the first axis 24A.

The second axis of rotation 24B runs parallel to the width dimension of the cube and rotation about this axis is also in the depthwise direction. The vector of the rotation is coincident with the second axis 24B.

When the GUI 10 is used as a menu, the plurality of different appearances of the visual entity presents one or more user selectable options 30 and/or one or more information items to the user. In the example illustrated, several faces of the cube each present a multiplicity of different user selectable options 30. The options 30 presented within a face may be ordered according to likelihood of user selection i.e. by an historic popularity of selection. The more often an option is selected, the higher it will be placed with the list of options.

The initial orientation of the 3D object when the menu is initialized may also be determined by historic information. The face presented on initialization may be that face which has the option that has, in the past, been most commonly selected immediately after initialization.

The menu may be organized as a hierarchical tree 40 as illustrated in FIG. 2. A hierarchical tree 40 comprises a plurality of branch nodes B and a plurality of leaf nodes L arranged on different hierarchical levels. Every branch node is connected to one or more branch nodes and/or one or more leaf nodes in a next lowest hierarchical level and is connected to a branch node in a next highest hierarchical level, if any. Every leaf node is connected to a branch node in a next highest hierarchical level and to nothing in the next lowest hierarchical level.

In this example, each node of the first hierarchical level (Level 1) is associated with a different face of the cube. A face includes an indication of the nodes in the next lowest hierarchical level (Level 2), if any, that depend from the node associated with the face.

The above described GUI 10 is used for inputting an access code. The access code corresponds to a combination of different rotations of the 3D object.

If one considers the cube example of FIG. 1, then rotation may be about the two axes 24A, 24B in 2 directions—clockwise or anticlockwise. If the two vectors of rotation are represented as (x, y) where x is the magnitude of the rotation vector aligned with the second axis 24B and y is the magnitude of the rotation vector aligned with the first axis 24A, and if each 90 degree rotation is considered to be 1 unit of rotation and the clockwise direction is considered to be positive and the anti-clockwise direction negative, then a combination may be represented as a series of vector pairs e.g. (3,0), (−2, 0), (0,−4), (2,0), (0,l 2). In this example, an access code corresponds to a predefined sequence of rotations of the 3D object and is thus independent on an initial starting orientation of the 3D object.

Alternatively, the six different faces of the cube may labeled and the combination may be an ordered sequence of faces that are presented to the user with at least predefined threshold hiatus. In this example, an access code corresponds to a predefined sequence of rotations of the 3D object starting from a particular initial orientation of the 3D object. The required rotations are therefore dependent on the original orientation of the 3D object.

The access code may, for example, be used to replace a PIN code e.g. for authenticating a user or for unlocking a device or function or for accessing a specified function which may be application specific.

Alternatively or additionally an access code may be used to make a hidden feature available for use. A correctly input access code may enable a new function or service or be used to discover an ‘Easter Egg’. For example, an SMS could be sent to a user with the combination to ‘unlock’ a hidden game.

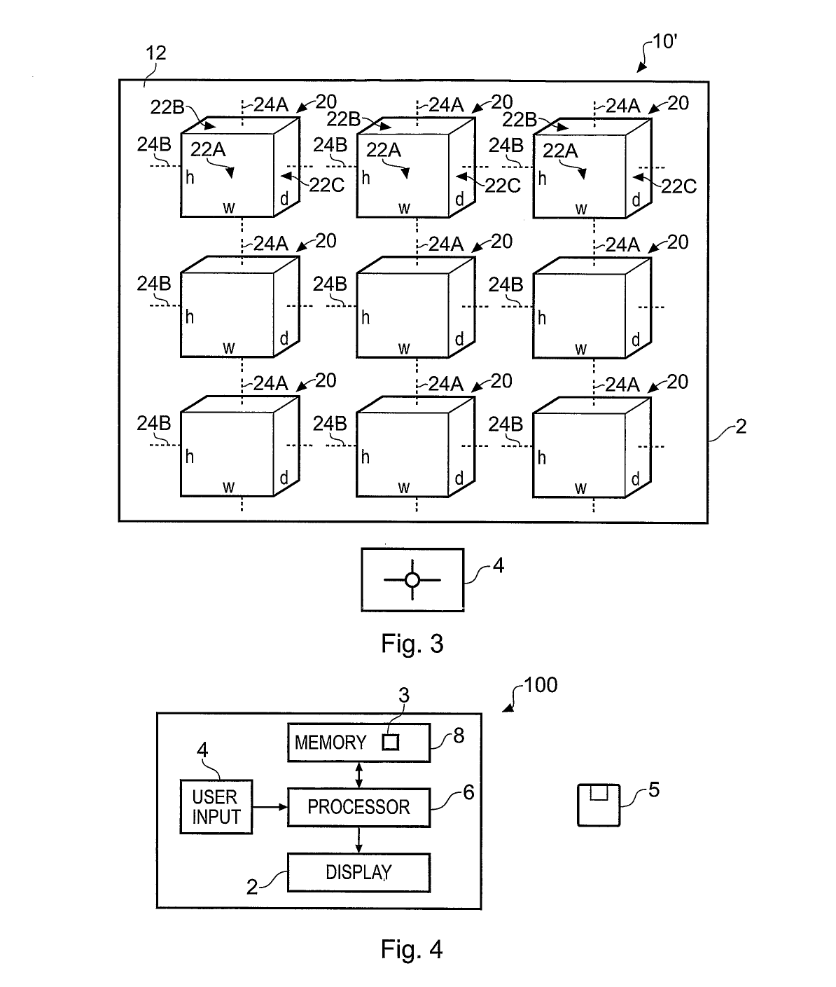

FIG. 3 schematically illustrates a graphical user interface (GUI) 10′ according to a second embodiment.

The GUI 10′ provides an output via a display area 12 provided by a display 2 and, optionally, a loudspeaker (not illustrated) and receives input from a user via one or more appropriate user input devices 4. A user input device 4 may be a device that is physically separated from the display 2 such as a keypad, joystick etc. or may be integrated with the display 2 as a touch screen.

The GUI 10′ provides, in the display area, a plurality of visual entities 20. A visual entity 20 visually represents a three dimensional (3D) object, which in this example is a cube. The 3D objects have a common height dimension h, a common width dimension w and a common depth dimension d, which are mutually orthogonal in the geometry of the 3D objects. In this example, the visual entities 20 represent the 3D objects as if viewed from a top-right perspective

A 3D object is rotatable to adopt any one of a plurality of different orientations. In each of these orientations, a different portion 22A, 22B, 22C . . . of a surface area of the 3D object is presented to the user. The visual entity has a different appearance for each orientation of the 3D object and each appearance reproduces a corresponding different one of the plurality of portions 22A, 22B . . . of the surface area of the object. User input via the user input device 4 changes the entity from one appearance to another such that the 3D object represented by the entity rotates in a manner controlled by the user.

In the illustrated example, each cube is rotatable to adopt any one of six different orientations. In each of these orientations, a different face 22A, 22B, 22C . . . of the cube is presented to the user. A visual entity has a different appearance for each orientation of its 3D object and each appearance reproduces a corresponding different face of the cube. User input via the user input device 4 changes the entity from one appearance to another such that the 3D object represented by the entity rotates in a manner controlled by the user so that a desired face 22A, 22B, 22C of the cube can be presented to a user.

A 3D object is rotatable about one or more axes of rotation. In the example illustrated, a first axis of rotation 24A is coincident with one axis of rotational symmetry of the 3D object and a second axis of rotation 24B is coincident with a different axis of rotational symmetry of the 3D object. The axes of rotation 24A, 24B are fixed and do not rotate with rotation of the 3D object.

The first axis of rotation 24A runs parallel to the height dimension and rotation about this axis is in the depthwise direction. The vector of the rotation is coincident with the first axis 24A.

The second axis of rotation 24B runs parallel to the width dimension and rotation about this axis is also in the depthwise direction. The vector of the rotation is coincident with the second axis 24B.

When the GUI 10 is used as a menu, the plurality of different appearances of the different visual entities presents one or more user selectable options 30 and/or one or more information items to the user. In the example illustrated, several faces of the cubes each present a multiplicity of different user selectable options 30. The options 30 presented within a face may be ordered according to likelihood of user selection i.e. by an historic popularity of selection.

The initial orientation of the 3D objects when the menu is initialized may also be determined by historic information. The face presented on initialization may be that face, for that object, which has the option that is most commonly first selected from that object after initialization.

The menu may be organized as a hierarchical tree. A hierarchical tree comprises a plurality of branch nodes and a plurality of leaf nodes arranged on different hierarchical levels. Every branch node is connected to one or more branch nodes and/or one or more leaf nodes in a next lowest hierarchical level and is connected to a branch node in a next highest hierarchical level, if any. Every leaf node is connected to a branch node in a next highest hierarchical level and to nothing in the next lowest hierarchical level.

The menu may provide applications. An object may be used to present a set of similar applications e.g. Office applications where each side of the object is associated with a different application. Alternatively, each side of an object may be used to present a set of similar applications as a user-selectable list.

In one example, each node of a first hierarchical level (Level 1) is associated with a different cube. Each node of a second hierarchical level (Level 2) is associated with a face of the cube associated with the node from which it depends. The face of a cube includes an indication of the nodes in the next lowest hierarchical level (Level 2), if any, to which the node associated with the face of the cube depends.

In the example illustrated in FIG. 3, the GUI 10′ comprises a rectangular array of nine cubes. The first hierarchical level therefore has nine nodes. Each cube has six faces, so each of the nine nodes has six nodes depending from it. Each cube face may comprise user selectable option(s) and/or information item(s) (leaf node(s)) and/or user-selectable gateway(s) to a sub-menu (branch node(s)).

The GUI 10 may be used for inputting an access code. The access code corresponds to a combination of different rotations of one or more of the different 3D objects. The combination of rotations may involve different rotations of one of the 3D objects or the combination of different rotations may involve similar and/or different rotations of different 3D objects.

If one considers the cube example of FIG. 3, then rotation may be of any of the nine cubes, about two axes 24A, 24B in 2 directions—clockwise or anticlockwise. A rotation may be represented as (x, y, z) where x is the magnitude of the rotation vector aligned with the second axis 24B, y is the magnitude of the rotation vector aligned with the first axis 24A, and z identifies a cube for rotation by a number between 1 and 9. Then if each 90 degree rotation is considered to be 1 unit of rotation and the clockwise direction is considered to be positive and the anti-clockwise direction negative, then a combination may be represented as a series of vector triplets e.g. (1, 0,1), (0, −2, 9), (2, 0, 3); (−2, 0, 5), (0, 3, 5). The first triplet indicates, for example, that cube 1 should be rotated by 90 degrees in a clockwise direction about the second axis 24B. Thus, an access code corresponds to a predefined sequence of rotations of different 3D objects and is independent of an initial starting orientation of the 3D object.

Alternatively, the six different faces of each cube may be labeled and the combination may be an ordered sequence of specific arrays of faces that are presented to the user. In this example, an access code corresponds to a predefined sequence of rotations of certain ones of the 3D objects starting from a particular combination of orientations of the 3D objects. The required rotations are therefore dependent on the original orientation of the 3D object.

The access code may, for example, be used to replace a PIN code e.g. for authenticating a user or for unlocking a device or function or for accessing a specified function which may be application specific.

Alternatively or additionally an access code may be used to make a hidden feature available for use. A correctly input access code may enable a new function or service or be used to discover an ‘Easter Egg’.

FIG. 4 schematically illustrates an electronic device 100. Only the features referred to in the following description are illustrated. It should, however, be understood that the device 100 may comprise additional features that are not illustrated. The electronic device 100 may be, for example, a personal computer, a personal digital assistant, a mobile cellular telephone, a television, a video recorder in combination with a television, or any other electronic device that uses a graphical user interface 10, 10′.

The illustrated electronic device 100 comprises: a user input 4, a memory 8, a display 2 and a processor 6. The processor 6 is connected to receive input commands from the user input 2 and to provide output commands to the display 2. The processor 6 is also connected to write to and read from the memory 8.

The user input 2 is used for selection and rotation as described above. It may be a single device such as a joystick, roller, touch-screen, mouse, track-ball etc. or a plurality of separate devices.

The memory 8 stores computer program instructions 3, which when loaded into the processor 6, enable the processor 6 to control the operation of the GUI 10, 10′ described above. The computer program instructions 3 provide the logic and routines that enables the electronic device 10 to present the entity or entities 20, to rotate the object or objects represented by the entity or entities, and to convert a combination of rotations to an access code.

The computer program instructions 3 may arrive at the electronic device 100 via an electromagnetic carrier signal or be copied from a physical entity 5 such as a computer program product, a memory device or a record medium such as a CD-ROM or DVD.

In some types of electronic devices dual user interfaces are provided. For example, in some types of mobile cellular telephones the mobile cellular telephone has a closed configuration in which a reduced display area 12 is visible and an open configuration in which a larger display area 12 is visible. In the closed configuration, a GUI as illustrated in FIG. 1 may be used and in the open configuration a GUI as illustrated in FIG. 3 may be used.

Although embodiments of the present invention have been described in the preceding paragraphs with reference to various examples, it should be appreciated that modifications to the examples given can be made without departing from the scope of the invention as claimed. For example, although the GUI has been described using cubes as objects, it should be recognized that any suitable object may be represented, for example, cylinders, polyhedrons, spheres, pyramids etc

In addition, although in the embodiments described above a 3D object was rotatable about the first and second axes, the 3D object may also be rotatable about a third axis that is parallel to the depth dimension and orthogonal to the first and second (orthogonal) axes. Thus each cube may be rotated to present one of six different faces and each face can have four different orientations, which are provided by rotation about the third axis. Each cube can therefore adopt one of twenty-four different orientations.

An access code may be defined as a sequence of vectors where each vector defines what is to be rotated and defines the extent of the rotation. What is to be rotated may be implicitly defined if there is only one 3D object or explicitly defined if there is more than one 3D object. The extent of rotation may be defined as a quantity of rotation about any of one, two or three axes. An access code may, for example, only involve the rotation of only one (or another sub-set) of the 3D objects displayed or rotation of all the 3D objects displayed. An access code may, for example, only involve rotation about only one (or another sub-set) of the axes available for rotation of the 3D object(s) or rotation about all the axes available for rotation of the 3D object(s).

In the preceding examples, the object has had a fixed appearance. Each face has had a position relative to other faces and the next face presented to a user depended upon the current face presented and the direction and extent of rotation. It may also be possible to use the GUI 10, 10′ in a different manner. Each entity 20 may be associated with a list of items. The currently highlighted item in the list is displayed within the face of the object presented to the user. A rotation of the object, in any direction, by 90 degrees scrolls one item within the list thereby highlighting the next item in the list. This next item is then displayed in the face of the object presented to the user.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. A graphical user interface, for inputting an access code, comprising:
one or more entities visually representing, respectively, one or more three dimensional objects that have a first height dimension, a second width dimension and a third depth dimension; and
a user input for controlling rotation of the one or more respective three dimensional objects at least in the third depth dimension, wherein a defined access code corresponds to a combination of different rotations of at least one of the one or more three dimensional objects.

2. A graphical user interface as claimed in claim 1, wherein rotation of at least one three dimensional object is about at least an axis parallel to the height dimension.

3. A graphical user interface as claimed in claim 1, wherein rotation of at least one three dimensional object is about at least an axis parallel to the width dimension.

4. A graphical user interface as claimed in claim 1, wherein rotation of at least one three dimensional object is about at least an axis parallel to the depth dimension.

5. A graphical user interface as claimed in claim 1, wherein the combination of different rotations includes rotations about different axes of rotation.

6. A graphical user interface as claimed in claim 1, wherein rotation of a three dimensional object is about multiple axes.

7. A graphical user interface as claimed in claim 1, comprising multiple entities, each of which visually represents a respective three dimensional object and wherein the user input is operable to control individually the rotation of each of the three dimensional objects, wherein a defined combination of different rotations of different ones of the three dimensional objects corresponds to a defined access code.

8. A graphical user interface as claimed in claim 7, wherein the multiple entities represents the same shape of object.

9. A graphical user interface as claimed in claim 7, wherein the multiple entities are organized as a grid array.

10. A graphical user interface as claimed in claim 1, wherein an entity represents a cuboid.

11. A graphical user interface as claimed in claim 1, wherein a defined access code corresponds to a predefined sequence of orientations of the one or more three dimensional objects.

12. A graphical user interface as claimed in claim 5, wherein a defined access code corresponds to a predefined sequence of rotations of the one or more three dimensional objects.

13. A graphical user interface as claimed in claim 1, wherein an access code is for user authentication.

14. A graphical user interface as claimed in claim 1, wherein an access code is for the enablement of a new function or service.

15. A graphical user interface as claimed in claim 1, wherein an access code performs an unlocking function.

16. A graphical user interface as claimed in claim 7, wherein the graphical user interface provides via the one or more entities a navigable menu, wherein navigation of the menu comprises at least rotation of the at least one of the one or more entities.

17. A graphical user interface as claimed in claim 16, wherein the menu provides user access for applications.

18. A graphical user interface as claimed in claim 7, wherein an entity
a) represents a three dimensional object that is rotatable to adopt any one of a plurality of different orientations in each of which a different portion of a surface area of the object is presented to the user,
b) has a plurality of different appearances, each of which reproduces a corresponding different one of the plurality of portions of the surface area of the object
and
c) changes from one appearance to another, in response to the user input, such that the three dimensional object represented by the entity rotates.

19. A graphical user interface as claimed in claim 18, wherein the plurality of different appearances presents one or more user selectable options and/or one or more information items.

20. A graphical user interface as claimed in claim 18, wherein at least one of the plurality of different appearances of the entity presents a multiplicity of user selectable options.

21. A graphical user interface as claimed in claim 20, wherein the multiplicity of user selectable options are ordered according to likelihood of user selection.

22. A graphical user interface as claimed in claim 18, wherein the appearance of an entity, on initializing the menu, is dependent upon historic information.

23. A graphical user interface as claimed in any one of claims claim 18, wherein
the graphical user interface is used as a menu that is organized as a hierarchical tree comprising a plurality of branch nodes and a plurality of leaf nodes arranged on different hierarchical levels, wherein every branch node is connected to one or more branch nodes and/or one or more leaf nodes in a next lowest hierarchical level and is connected to a branch node in a next highest hierarchical level, if any, and
wherein every leaf node is connected to a branch node in a next highest hierarchical level and to nothing in the next lowest hierarchical level, each node of the a first hierarchical level being associated with a different one of the plurality of appearances of an entity wherein the appearance of an entity includes an indication of the nodes in the next lowest hierarchical level, if any, to which the node associated with the appearance is connected in the hierarchical tree.

24. A graphical user interface as claimed in claim 23, wherein a leaf node is a user-selectable option within the menu.

25. A method for enabling input of an access code, comprising:
displaying one or more entities visually representing, respectively, one or more three dimensional objects that have a first height dimension, a second width dimension and a third depth dimension; and
controlling, in response to user input, rotation of the one or more respective three dimensional objects at least in the third depth dimension, wherein a defined access code corresponds to a combination of different rotations of at least one of the one or more three dimensional objects.

26. An electronic device comprising:
a display for displaying one or more entities visually representing, respectively, one or more three dimensional objects that have a first height dimension, a second width dimension and a third depth dimension; and
a user input for controlling rotation of the one or more respective three dimensional objects at least in the third depth dimension, wherein combination of different rotations of at least one of the one or more three dimensional objects corresponds to a defined access code.

27. A computer program which when loaded into a processor enables a graphical user interface, for inputting an access code, the graphical user interface comprising:
one or more entities visually representing, respectively, one or more three dimensional objects that have a first height dimension, a second width dimension and a third depth dimension; and
a user input for controlling rotation of the one or more respective three dimensional objects at least in the third depth dimension, wherein a combination of different rotations of at least one of the one or more three dimensional objects corresponds to a defined access code.

28. A graphical menu for operation by a user, the menu simultaneously comprising a first entity and a second entity,
wherein the first entity:
a) represents a first three dimensional object, wherein the first three dimensional object is rotatable to adopt any one of a first plurality of different orientations in each of which a different one of a first plurality of different portions of a surface area of the first three dimensional object is presented to the user,
b) has a first plurality of different appearances, each of which reproduces a corresponding different one of the first plurality of portions of the surface area of the first three dimensional object and each of which presents one or more user selectable options and/or one or more information items to the user; and
c) changes from one appearance to another, in response to a user input such that the first three dimensional object represented by the first entity rotates,
wherein the second entity:
d) represents a second three dimensional three dimensional object, wherein the second three dimensional object is rotatable to adopt any one of a second plurality of different orientations in each of which a different one of a second plurality of different portions of a surface area of the second three dimensional object is presented to the user,
e) has a second plurality of different appearances, each of which reproduces a corresponding different one of the second plurality of portions of the surface area of the second three dimensional object and each of which presents one or more user selectable options and/or one or more information items to the user; and
f) changes from one appearance to another, in response to a user input such that the second three dimensional object represented by the second entity rotates.

29. A graphical menu for operation by a user, the menu comprising:
an entity:
a) representing a virtual three dimensional object, wherein the object is rotatable to adopt any one of a plurality of different orientations in each of which a different one of a plurality of different portions of a surface area of the object is presented to the user;
b) has a plurality of different appearances, each of which reproduces a corresponding different one of the plurality of portions of the surface area of the object;
c) and the entity changes from one appearance to another, in response to a user input, such that the virtual three dimensional object represented by the entity rotates,
wherein at least one of the plurality of different appearances of the entity presents a multiplicity of user selectable options.

30. A method of inputting an access code using a navigable menu, comprising:
navigating a predefined route within the menu without selecting a menu item.
